(19) United States
(12) Patent Application Publication
(10) Pub. No.: US 2004/0093797 A1
(43) Pub. Date: May 20, 2004

(54) Integrated auto-thermal reformer

(76) Inventors: Billy E. Bingham, Lynchburg, VA (US); Ray L. Sullivan, Lynchburg, VA (US); Stephen W. Scoles, Lynchburg, VA (US); Mark A. Perna, Alliance, OH (US); Andrew F. Kisik, Homeworth, OH (US)

Correspondence Address: BWX TECHNOLOGIES, INC., 1562 BEESON STREET, ALLIANCE, OH, 44601, US

(21) Appl. No.: 10/295,405

(22) Filed: Nov. 15, 2002

(51) Int. Cl. F17D 1/04

(52) U.S. Cl. 48/198.7; 48/61; 48/62 R; 48/105; 48/107; 48/95; 48/127.9; 48/198.1; 48/214 R; 48/214 A; 48/215

(57) ABSTRACT

A reactor vessel for the catalytic reforming of air and steam-fuel mix into a hydrogen rich output gas is designed to relevant pressure code requirements. The steam-fuel mix and/or air provided to the vessel may be internally pre-heated prior to contacting the catalyst. Reformate is selectively directed into a recuperator to accomplish such heating. A bypass valve to divert reformate around the recuperator is also provided to allow control of the reaction conditions. Notably, this control may be performed manually or by way of an automated system. The resulting vessel enhances the safety and performance of the vessel, and it is more easily integrated into a complete fuel processor system. A method for achieving these goals is also described.

This invention was conceived under government contract N00014-00-C-0433. The United States' government may retain certain rights to this invention. This invention is also related to U.S. Ser. No. 09/710,173, filed Nov. 10, 2000 (“Selectively Controllable Modular Auto-Thermal Reformer and Method for Same”), which is currently assigned to the same entities as the present invention and whose disclosure is incorporated by reference herein.

### FIELD AND BACKGROUND OF INVENTION

The present invention relates generally to the field of fuel processors and in particular to a new and useful integrated auto-thermal reformer for reforming hydrocarbon-based fuels to make hydrogen rich gas.

Fuel cell systems that generate electricity to provide decentralized energy supplies are the subject of research activity throughout the world. However, such systems require a hydrogen rich fuel gas. Given practical and safety concerns, in-situ generation of such hydrogen rich gas is currently the preferred method of fueling such fuel cell systems, thereby giving rise to the specialized field of reforming.

Reforming is a term of art used to describe the actual process of generating hydrogen rich gas. Reformers that generate hydrogen rich gas on an industrial scale have been known for decades; however, these industrial scale reformers cannot be efficiently scaled down for decentralized and/or mobile applications in the range of several tens or hundreds of kilowatts (kW). Steam-reforming and auto-thermal reforming (ATR) are specific methods of reforming.

In steam-reforming, fuel to be reformed is exposed to a catalyst at an appropriate reaction temperature in a controlled environment. Those skilled in the art will readily appreciate the multitude of embodiments presently available in the steam reforming field.

In ATR, fuel is partially reacted by adding air to the fuel and steam mixture in the reformer to heat the mixture to appropriate reaction temperatures. ATR is advantageous because it has lower steam requirements (e.g. a molar steam to carbon ratio of about 2.5 to 3.5) than steam reforming and it improves efficiency in comparison to steam-reforming. ATR relies on flameless oxidation of fuel with oxygen from the air, thereby resulting in combustion of about 20 to 33% of the fuel and a release of the heat needed to drive the ATR reforming reactions. The unoxidized fuel endothermically reacts with steam to create a mixture of hydrogen, carbon monoxide and carbon dioxide. An ATR reformer quickly adapts to new operating conditions because of its direct coupling and dynamic ability to respond to changing loads. Furthermore, ATR does not require additional external burners (and their attendant power supplies), making the system less complex and less expensive.

Notably, current technology for reforming reactions require very specific operating conditions. For example, some catalysts may be irreparably harmed by contaminants present in many feed fuels. Consequently, reformers are almost always integrated into a more complete “fuel processor” design. Such fuel processors take a particular feed stream, such as gasoline, and refine the incoming liquid to be suitable for reforming. Likewise, a fuel processor system may alternatively or additionally contain processing reactions downstream of the reformer in order to further prepare the reformate (i.e., the reformed feed stream) for its final intended use. The individual reactor modules of fuel processors can be further integrated and engineered in order to optimize heat and reactant utilization therein.

Finally, it is important to note that economic and practical aspects dictate that universally available fuels are the best choices for design of reforming systems (be it either steam or ATR). Natural gas is particularly attractive for stationary applications, whereas use of liquid hydrocarbon fuels is more likely in the mobile sector. In either case, a reforming system must not only be suited to the particular fuel of choice, but to the limitations of the intended use (i.e., stationary or mobile).

### SUMMARY OF INVENTION

The present invention is drawn to an integrated auto-thermal reforming (IATR) reactor designed to exacting performance requirements. In particular, the invention allows for the final heat-up of the steam-fuel mixture inside of a pressure vessel drawn to relevant pressure code standards (e.g., ASME, etc.). It is anticipated that this IATR reactor would be integrated into a larger fuel processing system.

The invention enhances the safety and performance of the reforming reaction occurring within the vessel, as compared to previously known ATR reactors. For example, the IATR vessel disclosed herein minimizes the residence time of the steam-fuel mixture as it is heated to reaction temperatures within the vessel. This decreased residence time reduces the potential for carbon or soot formation in the steam-fuel feed line and, as such, marks a significant improvement over previous ATR reactors. Likewise, the IATR vessel simplifies the control of the reactor inlet temperature and reduces internal stresses around the pressure boundary of the vessel. Finally, the IATR reactor allows for a more uniform flow and temperature distribution within the reactor itself. In sum, the IATR reactor outperforms and improves upon previous ATR vessels, while at the same time providing a lighter weight vessel with simplified control mechanisms.

The invention comprises a pressure tolerant outer shell with first and second reactants inlets and a product outlet integrated therein. Reactant distribution means for mixing the reactants in a pre-determined temperature range in order to create a product are connected to the inlets. Notably, the distribution means must be located entirely within the outer shell. Recuperator means for exchanging heat between the reactant product and at least one of the reactants is fluidically connected to the distribution means and the outlet. A bypass means is also provided such that a portion of the product may be selectively diverted away from the recuperator means in order to control the temperature range at which the reaction product is created. The bypass means must be fluidically connected to the recuperator means and the outlet.

An improved method for reforming is also described. In particular, the known reforming method of providing air and a steam-fuel mix and then mixing the two in the presence of an endothermic catalyst to produce a hydrogen-rich reformate is improved upon by providing a pressure vessel including an internal recuperator shell for providing heat to the catalyst. The catalyst itself is located entirely within a designated reaction zone next to the recuperator shell and completely within the pressure vessel. Prior to mixing the air and the steam-fuel mix, it is separately pre-heated in the pressure vessel but in an area upstream from the reaction zone. Subsequent to the reforming reaction, a portion of the hydrogen rich gas produced by that reaction is then diverted into the recuperator shell prior to being removed from the pressure vessel in order to provide heat to the steam-fuel mix and/or the catalyst itself. Heat can also be provided to the air when it is mixed with the steam-fuel mix in the swirl tubes.

The various features of novelty which characterize the invention are pointed out with particularity in the claims annexed to and forming part of this disclosure. For a better understanding of the present invention, and the operating advantages attained by its use, reference is made to the accompanying drawings and descriptive matter, forming a part of this disclosure, in which a preferred embodiment of the invention is illustrated.

### BRIEF DESCRIPTION OF THE DRAWINGS

In the accompanying drawings, forming a part of this specification, and in which reference numerals shown in the drawings designate like or corresponding parts throughout the same:

FIG. 1 is an exterior side view of the present invention.

FIG. 2 is a first longitudinal cross-sectional side view of the present invention, but with certain elements omitted to better illustrate the distribution device.

FIG. 3 is a second longitudinal cross-sectional side view of the present invention, but with certain elements omitted to better illustrate the catalyst support structure.

FIG. 4 is a detailed cross sectional side view of the catalyst support structure in a preferred embodiment of the present invention.

FIG. 4A is lateral cross section of the present invention taken along line A-A shown in FIG. 2.

FIG. 4B is lateral cross section of the present invention taken along line B-B shown in FIG. 2.

FIG. 5 is a longitudinal cross-sectional side view of the present invention, but with certain elements omitted to demonstrate the reactant flow paths.

### DESCRIPTION OF THE PREFERRED EMBODIMENTS

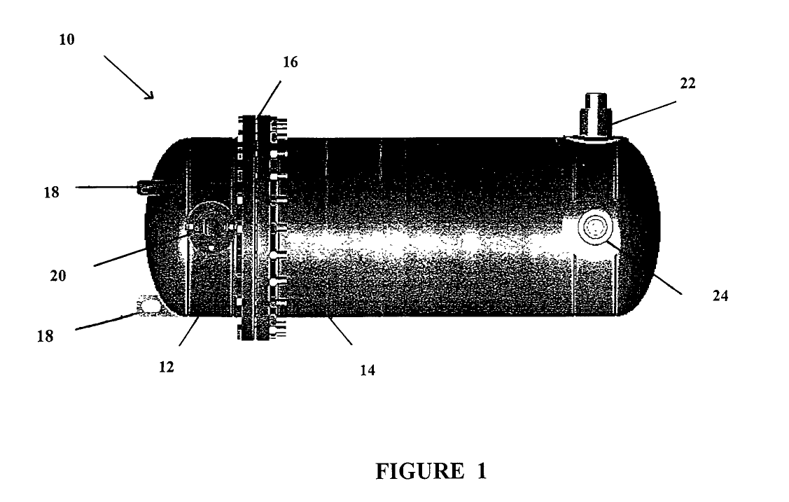

Referring now to the drawings, where each reference numeral represents the same element throughout, the IATR vessel contemplated by the present invention is shown in FIG. 1. The invention generally comprises an integrated autothermal reformer, more generally referred to hereafter as pressure vessel 10. Significantly, vessel 10 should be constructed to meet all relevant pressure vessel requirements (specifically, AMSE code, any legally required standards and/or other similar types of codes and laws), as the operating parameters needed by the reforming reactions will generate considerable heat, and the vessel itself is pressurized by the feed streams. Also, as used throughout this specification, the term “vessel” is intended to refer to the entire IATR system, rather than being limited to merely the exterior pressure-tolerant container.

The exterior of vessel 10 includes end caps 12, 14, preferably held together by bolted flange joint 16. Notably, while applicants have chosen to illustrate the external components of vessel 10 as containing two such end caps, those skilled in the art may be able to combine, modify or eliminate the end caps 12, 14 without departing from the inventive principles contemplated herein. Also, it is possible to construct the exterior of vessel 10 with additional sections beyond end caps 12, 14 illustrated herein, and these end caps maybe incorporated as part of the outer shell described in detail below. Likewise, while bolted flange joint 16 is illustrated, any appropriate connecting device can be used.

Air inlet 20 is fashioned into end cap 12, while at least one reformate outlet 22 and bypass valve 24 may be included on end cap 14. Notably, a steam-fuel inlet (preferably fashioned into end cap 14, but not shown in FIG. 1) is also required. The provision of separate end caps 12, 14 should simplify maintenance of the IATR vessel 10, insofar as end cap 12 may be easily removed in order to access the internals of the vessel itself. Optionally, lifting lugs 18 may be included on either or both end caps 12, 14 in order to further simplify installation and maintenance of vessel 10. Likewise, air inlet 20, reformate outlet 22, bypass valve 24 and steam-fuel inlet (not shown) are not necessarily limited to the specific locations shown on FIG. 1, and all of these elements may be placed in any convenient location on either one or both of the end caps 12, 14. Finally, while two end caps have been shown, it may be possible to fashion vessel 10 from any number of appropriate vessel body parts, provided of course the final construction meets the operating requirements of the reforming reactions occurring therein.

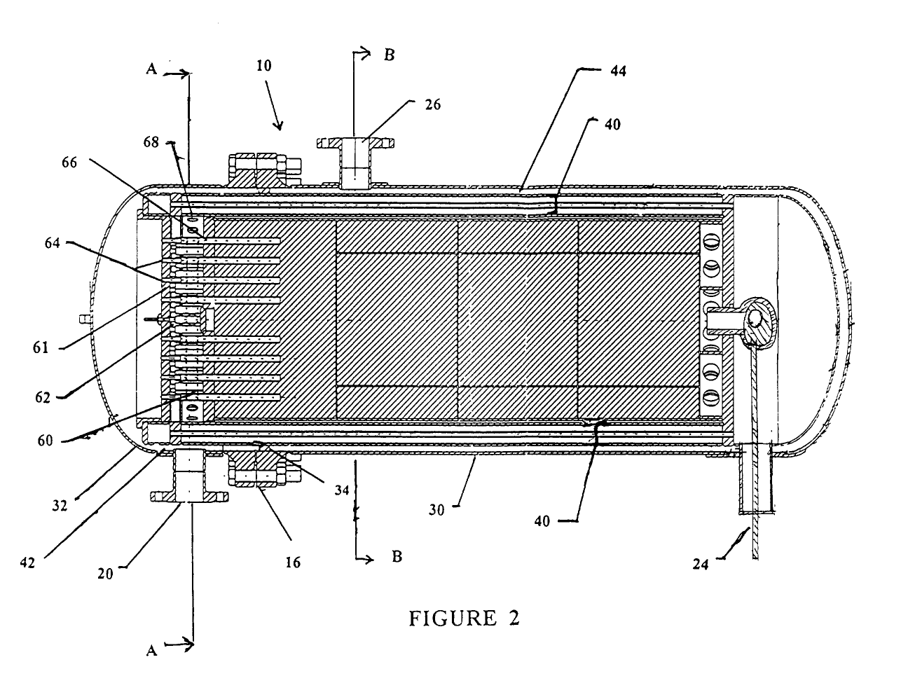

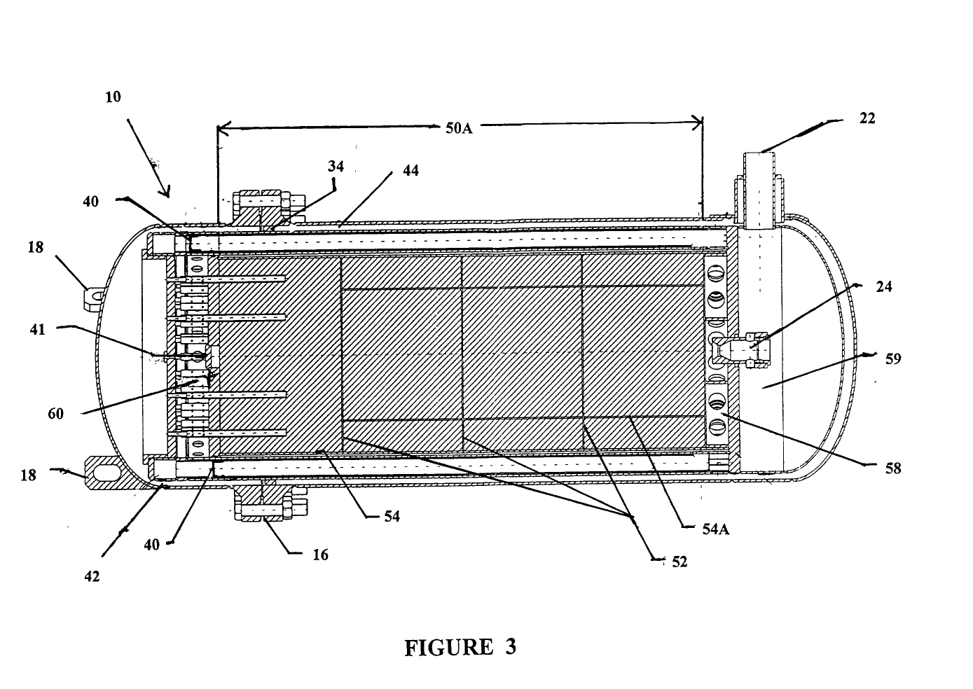

FIGS. 2 and 3 illustrate a longitudinal cross section of a preferred embodiment of the invention. Vessel 10 has two pieces forming an outer shell 30, 32 and a single interior recuperator shell 40. Flange joint 16 may be fashioned as an integral part of outer shell 30, 32, along with any number of lifting lugs 18. Likewise, air inlet 20, bypass valve 24 and steam-fuel inlet 26 may be integrated into the outer shell pieces 30, 32 (reformate outlet 22 is not shown in FIG. 2, but may be similarly provided).

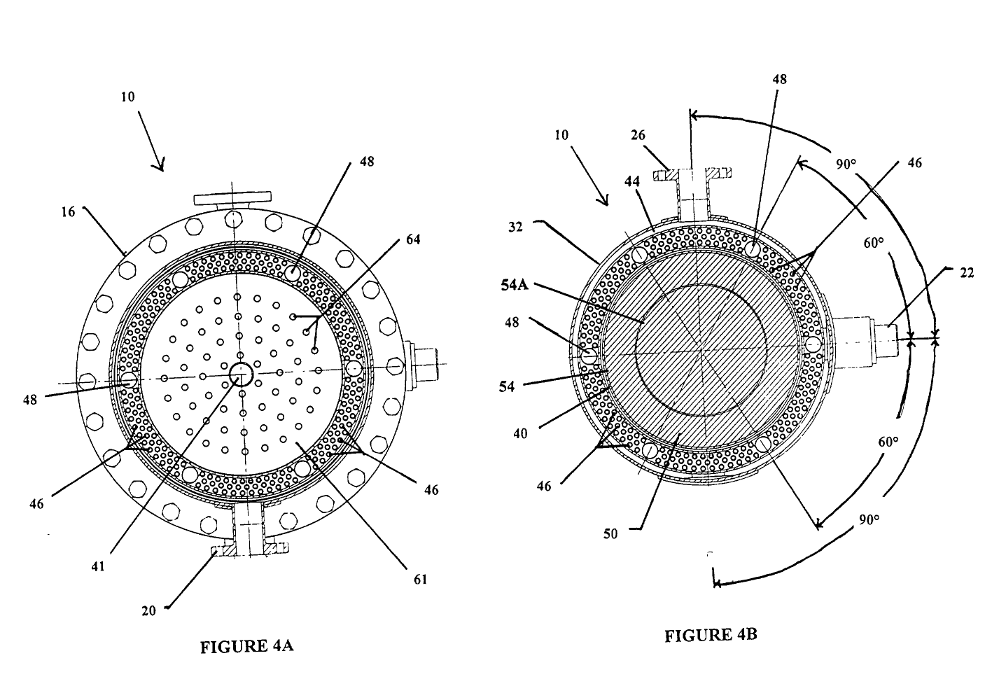

A recuperator shell 40 for exchanging heat between the reactants is contained entirely within the pieces of the outer shell 30, 32, thereby forming an annular space therebetween. As with any recuperator, shell 40 contains a plurality of tubesheets specifically designed for heat exchange purposes between the fluids present in vessel 10, as well as an inner and outer shell. Specifically, a steam-fuel mix enters some of the tubesheets via a series of inlets fashioned into any appropriate location on the exterior of shell 40, and the mix is subsequently expelled into the interior of shell 40 via steam-fuel mixture inlet ports 68. Similarly, outlet ports 58 may be connected to the tubesheets at one end of shell 40 in order to permit hot reformate to enter the recuperator tubesheets, while reformate exits the tubesheets via a plenum connected to reformate outlet 22 (however, it is important to note that reformate must pass by bypass valve 24 prior to entering the reformate tubesheets, see below). The reformate and steam-fuel mix tubesheets can be arranged in a counterflow configuration, with the precise location of reformate and steam-fuel tubes being shown and described in greater detail in FIGS. 4A and 4B below, in order to allow for heating of all reactants/catalyst elements and for thermodynamic optimization of the entire IATR process.

Significantly, it is possible to vary the precise flowpath of the steam-fuel mix and/or the reformate without departing from the principle of the invention. For example, in order to simplify the design, steam-fuel mix may be routed to flow from steam-fuel channel 44 into an annular header connected to recuperator tubes 46, 48. Heat passes from the reformate, which is itself routed to flow through the outer shell of recuperator 40 in a counterflow configuration, to the steam-fuel mix. The steam-fuel mix then flows back toward steam-fuel injection plenum 62 and the swirl mixer tubes 66 (see below) within the annulus formed by the inner and outer shells of the recuperator 40.

In any event, tubesheets (and/or the inlets, outlets and headers necessitated thereby) should form a complete enclosure generally designated as shell 40. The length, size and overall construction of shell 40 may vary according to the expected heat exchanging needs of the reactor 10. The annular space between shell 40 and outer shell pieces 30, 32 is further delineated by support ring 34 or similar structure, which provides support for the interior elements and separates the annular space into air channel 42 and fuel-steam channel 44.

A catalyst support structure 50 is contained entirely within, or alternatively as an integral part of, recuperator shell 40. The entire length of support structure is generally designated by element 50A in FIG. 3. Structure 50 is ideally composed of several distinct elements, including at least one screen 52 interposed within a outer support cylinder 54. Screens 52 optimally have a flat disk shape and are fixed to cylinder 54 along the edges so as to create a containment area (e.g., the screens 52 could intersect and be attached to the cylinder 54 at approximately a 90° angle, thereby occupying the vertical plane in FIG. 3; however, other configurations/angles are equally possible and, to be clear, screens 52 do not have to be attached to cylinder 54). Interior, concentric cylinders 54A may also be provided to give additional support to the overall support structure. A pre-heating/mixing chamber can also be included proximate to the distribution device 60, upstream of the first screen 52 and/or the cylinder 54 itself (see below for further description of the device 60).

Screens 52 and/or cylinder 54 can be made of inconel steel, or similar materials possessing good heat and corrosion resistance and thermal properties. Likewise, both screens 52 and cylinder 54A can be sheets of metal with perforations sized to retain a catalyst material or to enhance flow properties, although any means for holding a catalyst inside the pressure vessel should suffice, including but not limited to: catalyst coated plates or baffles, ceramic implements containing catalyst, packing material or ceramic coated packing material, and the like.

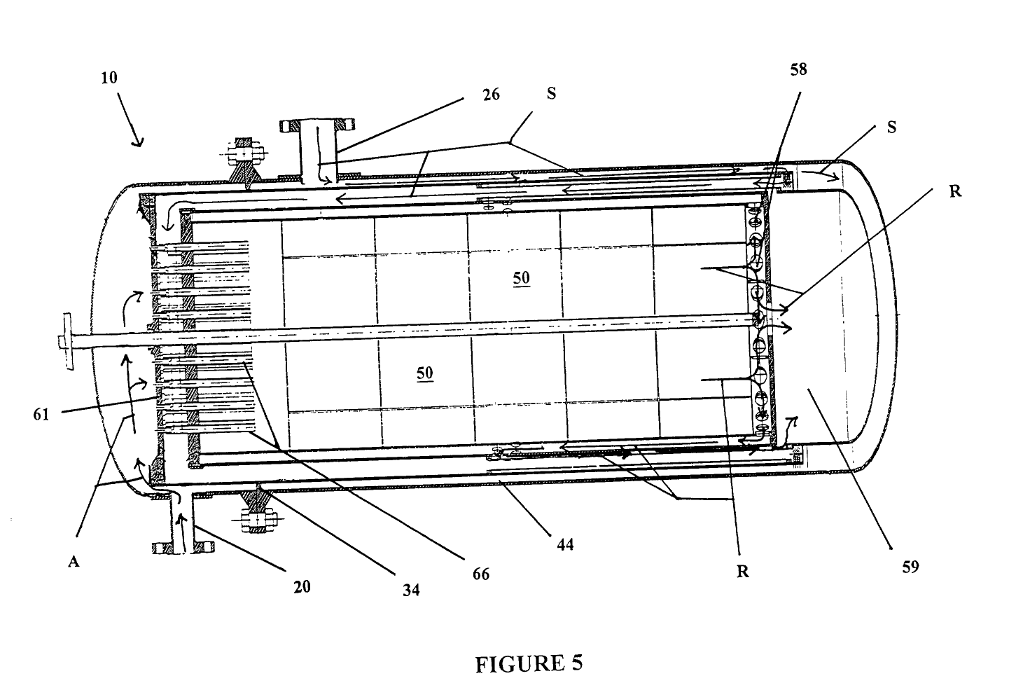

Reforming reactants (air and steam-fuel mix) enter the catalyst support structure 50 via distribution device 60, described below. Reformate exits out of the catalyst support structure 50 via outlet ports 58 at an opposite end from distribution device 60. Outlet ports 58 are fluidically connected to the chosen reformate flow path for the recuperator 40 (as described in FIG. 5 below, although it should be noted that an appropriate flow path could be formed by tubes 46, 48, the catalyst shell, the inner and outer shell the recuperator, and/or any annulus created between any of the aforementioned elements). However, at least some of the reformate must flow past bypass valve 24 prior to entering the recuperator 40. Reformate flows through the shell 40, exiting the tubesheets into collection plenum 59. Plenum 59 itself is fluidically connected to reformate outlet 22.

Turning to the preferred flow path of the reactants, steam-fuel mixture enters the vessel 10 via steam-fuel inlet 26. This mix flows through annular steam-fuel channel 44 and enters at least some of the tubesheets of shell 40 in order to transfer heat with the counterflowing reformate and/or the interior elements enclosed by shell 40. Hot steam-fuel mix then exits the tubesheets at a temperature preferably in the range of 800° to 1000° F. and passes into the distribution device 60 by way of inlet ports 68.

Air enters the vessel 10 via air inlet 20. Air then flows through annular air channel 42 and passes into distribution device 60. The air should also be preheated to the appropriate reforming reaction temperature, in the preferred range of 800° to 1000° F. This heated air is mixed with hot steam-fuel mixture in the distribution device 60, which then injects the reactants into the catalyst bed located in catalyst support structure 50 to take part in the reforming reactions, described in greater detail below.

Distribution device 60 comprises: air injector plate 61, steam-fuel injection plenum 62, air injection apertures 64, swirl mixer tubes 66 and steam-fuel inlet ports 68. Air from annular air channel 42 passes through apertures on air injector plate 61 prior to the swirl mixer tubes 66, while steam-fuel injection plenum 62 collects steam-fuel from the recuperator 40 and supplies the same directly to the swirl mixer tubes 66 by way of a separate series of apertures which may be located in the sides of the swirl mixer tubes 66. This arrangement allows the steam-fuel mix to be entrained by the air passing through the mixer tubes 66. In turn, this mix of air and steam-fuel is immediately delivered into the catalyst bed and support structure, described above.

Swirl mixer tubes 66 extend into the main body of catalyst bed in catalyst support structure 50, preferentially into cylinder 54 but upstream of the first catalyst screen 52. Swirl mixer tubes 66 are designed to optimize the mixing of the air with the steam-fuel mix. Inlet ports 68 are fluidically connected to the tubesheets of shell 40, which transport steam-fuel mix.

It should be noted that both incoming air and steam-fuel mix are most preferably heated to temperatures of about 800° F. and 500° F., respectively, prior to entering vessel 10. This heating may be achieved by integrating the incoming streams with other portions of the fuel processor system upstream of vessel 10. Nevertheless, it may be possible for those skilled in the art to provide a recuperator shell 40 capable of performing a greater share of the work required to internally heat (i.e., within the vessel 10) the reactants to the necessary temperatures. Likewise, recuperator 40 may be designed to allow for concurrent heating of both the steam-fuel mix and the air in separate chambers by way of the hot reformate exiting the vessel 10. In any case, this pre-heating function should confine at least some of the high temperature operations to the internal baffle boundaries of vessel 10. Thus, in light of this heat optimization (as well as the compact design and pressure-code standards achieved by the present invention), the resulting reactor vessel 10 is more durable and capable of being more easily integrated into a fuel processor system.

Given the combination of catalyst support structure 50 and distribution device 60, it is apparent that air and steam-fuel mixture are individually pre-heated and mixed within vessel 10 prior to or concurrent with coming into contact with the catalyst material of structure 50. When mixed, the steam-fuel mix and the air combusts and, in the presence of a catalyst material, undergoes a chemical reaction wherein hydrocarbon chains are converted into hydrogen, carbon monoxide, carbon dioxide, water and/or smaller hydrocarbon chains (depending upon the catalyst material, the specific operating requirements of the overall fuel processor system, and other factors). Notably, the catalyst material may be any appropriate reforming catalyst known to those skilled in the art. Typically, these materials contain at least one metal, including but not limited to platinum, palladium, rhodium, and the like. In any event, reforming reactions are driven by the heat temperatures generated by the combustion reactions occurring within vessel 10, such that control of the operating temperature of the vessel 10 (which is synonymous with control of the combustion reactions therein) affords a concurrent level of control for the reformate produced thereby.

Bypass valve 24 is specifically designed to provide temperature control, along with concurrent control of the reforming vessel's overall performance and reformate output. In particular, temperatures in vessel 10 can be monitored by a thermocouple inserted into the vessel via thermocouple port 41. Based upon the observed temperature, bypass valve 24 may be selectively activated to direct reformate exiting via outlet ports 58 into the recuperator tubesheet and/or to divert reformate out of the vessel via reformate outlet 22 (note that a plenum may be constructed around reformate outlet 22 in order to further optimize operation). Ultimately, the bypass valve 24 operation should afford direct control of the steam fuel inlet temperature and, by diverting hot reformate directly from the catalyst outlet 58 to the reformate outlet 22 (i.e., away from the heat exchanging processes encountered by the tubesheet), an overall level of temperature control within the vessel 10 is achieved.

Bypass valve has generally been designated as reference element 24, shown in FIG. 2 to have a standard ball valve design. However, the valve 24 may have any configuration, and the invention specifically contemplates a wide array of valve designs so long as the valve 24 allows for the controlled release of reformate directly to the reformate outlet 22 without entering recuperator shell 40. This release will permit concurrent control of the operating conditions and, as a result, control of the formation of reformate (as mentioned above). Valve 24 may incorporate an automated or manually controlled system (not pictured) connected to the aforementioned thermocouple for operation of the valve 24 on the basis of temperature observed within the reforming reaction zone of vessel 10, or the valve may be controlled on a more selective basis by an operator. An air actuator controlled by the thermocouple 41 is believed to have particular usefulness for the design illustrated in FIGS. 2 and 3.

FIGS. 4A and 4B further illustrate one possible embodiment of vessel 10, as described above. FIG. 4A, a lateral cross-section taken along line A-A of FIG. 2, shows some of the internal components of distribution device 60. In particular, the apertures 64 of injection plate 61 can be seen, along with the thermocouple port 41 (located at the centerpoint). Down-flowing tubes 46 and up-flowing tubes 48 form the aforementioned tubesheets of the recuperator shell 40, which radially encloses the injection plate 61 (as well as all of the internal elements of shell 40) in FIG. 4A, thereby providing heat to the reactants and elements contained therein. Air inlet 20 and flange joint 16 can also be more clearly seen. An interior annular space for reactant flow and heat exchange therebetween is formed by the tubesheets and the catalyst support structure 50 in FIG. 4B.

FIG. 4B illustrates a cross section taken at the steam-fuel inlet 26 along line B-B. As above, tubes 46, 48 forming the tubesheet of shell 40 enclose the catalyst support structure 50. The annular space defined by outer piece 30 and shell 40 (and, more particularly, the annular steam-fuel channel 44) is more easily identified. Possible locations of steam inlet 26, and reformate outlet 22 can also be seen.

In this embodiment, steam-fuel is routed to flow within the annular space 44, and hot reformate flows through the tubes 46, 48 so as to provide heat to the steam-fuel mix on either side of the tubesheet (the tubesheet containing tubes 46, 48). However, it may be possible to have hot reformate flow through only tubes 46 or tubes 48, or to have reformate flow through the annulus defined by support structure 50 and the recuperator tubesheets so as to heat steam-fuel flowing through the adjacent tubesheet, without departing from the principles of this invention. Likewise, it may be possible to provide incoming air flow through some of the tubes of recuperator 40 as previously suggested. In essence, the primary motivation is to provide for heat exchange and thermodynamic optimization between the hot reformate and the incoming reactant(s).

FIG. 5 represents a separate, preferred embodiment for the flow path of reactants. Notably, this preferred flow path is distinct from those described in FIGS. 4A and 4B above. Line R represents reformate flow, line A shows air flow, and line S illustrates steam-fuel mix flow. It should be noted that, in comparison to FIGS. 1-3, the relative size of FIG. 5 has been altered and some elements have been omitted in order to better illustrate the flow passages.

As seen in FIG. 5, steam-fuel mix S enters the vessel 10 by way of inlet 26. Steam- fuel mix S then flows down and around the annular space 44, although the precise flowpath is illustrated on only the top portion of the drawing. Steam-fuel mix S enters the tubesheets of the recuperator and is redirected back toward the distribution device, where it enters swirl mixer tubes 66 by way of separate inlet ports along tubes 66.

Air enters the vessel 10 by way of inlet 20. As above, the flow chamber for the air A is actually an annular space, although the precise path is only illustrated on the bottom portion of the drawing. The air A is then directed toward the air injection plate 61, as its flow path is partially defined by support ring 34. Finally, the air A enters the swirl mixer tubes 66, where it is mixed with the steam-fuel mix and injected into the catalyst support structure.

Reformate R is formed within the confines of the catalyst support structure 50. Reformate R exits the support structure 50 at an end opposite from the distribution device via reformate outlet ports 58. Notably, these ports are connected to bypass valve (not shown) such that reformate R may be selectively channeled directly into the reformate collection plenum 59 and/or along a flow path which runs adjacent to the recuperator tubesheets. As above, the reformate flow path R is annular, although the illustration only includes reference line R on the bottom portion of the drawing.

In FIG. 5, for the sake of clarity, it must be noted that not all of the possible flow paths for S, R and A have been depicted. For example, with respect to lines S and R, these flow paths occur in annular spaces within the vessel 10; therefore, although line S only appears along the top portion of FIG. 5 and line R is only shown at the bottom, these flow paths will be duplicated in the entire annulus and the lines for each could be transposed on both the top and bottom portions of FIG. 5.

Similarly, the flow paths R and S in FIG. 5 both involve “counterflow”—that is, the direction of movement of these paths reverse course 180° in comparison to the initial defined pathway. The counterflow of R (i.e., the portion of line R whose arrows point to the right) actually occurs within a set of tubesheets which are themselves configured so that the counterflow of R may completely surround and encase the counterflow portion of S (i.e., the portion of line S whose arrows point to the left).

All elements of vessel 10 should be constructed from an appropriate material. To the extent that vessel 10 is designed to withstand extremes in terms of pressure and temperature, this material is ideally a steel, steel alloy or combinations thereof (with differing types being incorporated into the different elements). The precise gauge and type will be readily ascertainable by those skilled in the art. Also, in regards to the heat exchanging surfaces, it may be possible to incorporate heat exchanging fins and/or other such devices in order to accomplish the objects of this invention.

Although this reactor shows particular promise for catalytic reforming reactions, vessel 10 may be used in any operation wherein two incoming streams undergo a thermal reaction which relies upon heat exchange between the reactants and/or the reaction product. Thus, while the terms “air”, “steam/fuel” and “reformate” have been used above, it must be kept in mind that these terms are not confined to only a literal interpretation.

Distribution device 60 relies upon swirl mixing tubes 66. However, any device or means for mixing the incoming reactant streams should suffice.

Finally, recuperator shell 40 may be designed in any manner consistent with commonly accepted heat exchanging devices. Headers, inlets, outlets and pass through points (to allow fluids not in the tubesheets to pass into/out of the shell) can be provided as needed.

While specific embodiments and/or details of the invention have been shown and described above to illustrate the application of the principles of the invention, it is understood that this invention may be embodied as more fully described in the claims, or as otherwise known by those skilled in the art (including any and all equivalents), without departing from such principles.

We claim:

1. A pressure-tolerant reactor vessel comprising:
a pressure-tolerant outer shell;
a first reactant inlet penetrating the outer shell;
a second reactant inlet penetrating the outer shell;
a reaction product outlet penetrating the outer shell;
distribution means for mixing the first and second reactants at a selected temperature in order to create a reaction product, the distribution means located entirely inside of the outer shell;
recuperator means for exchanging heat between the reaction product and at least one of: the first reactant and the second reactant, the recuperator means located entirely inside of the outer shell and fluidically connected to the distribution means and at least one of: the first and second reactant inlets; and
bypass means for selectively diverting at least a portion of the reaction product away from the recuperator means in order to control the selected temperature, the bypass means fluidically connected to the product outlet and the recuperator means.

2. A reactor vessel according to claim 1, further comprising: catalyst means for inducing a reaction between the first reactant and the second reactant, the catalyst means being located entirely inside of the outer shell and proximate to the distribution means.

3. A reactor vessel according to claim 2, wherein the recuperator means comprises a recuperator shell having tubesheets for flow therethrough of at least one of: the first reactant, the second reactant, and the reaction product; and wherein the distribution means and the bypass means are fluidically connected to the recuperator shell.

4. A reactor vessel according to claim 3, wherein the distribution means comprises at least one swirl mixing tube fluidically connected to the recuperator shell at a position upstream of the catalyst means.

5. A reactor vessel according to claim 4, further comprising monitoring means for determining a temperature reading within the outer shell and creating an output signal indicative thereof.

6. A reactor vessel according to claim 5, wherein the bypass means includes an control mechanism for varying the portion of reaction product diverted away from the recuperator means based upon the output signal of the monitoring means.

7. A reactor vessel according to claim 6, wherein the catalyst means comprises a reforming catalyst and wherein the reaction product comprises a hydrogen-rich gas.

8. A reactor vessel according to claim 7, wherein the outer shell includes a first end cap, a second end cap and means for connecting the first and second end caps; wherein the reforming catalyst is retained within the recuperator shell by at least one catalyst screen; and wherein the monitoring means comprises a thermocouple.

9. A reactor vessel according to claim 1, further comprising monitoring means for determining a temperature reading within the outer shell and creating an output signal indicative thereof.

10. A reactor vessel according to claim 9, wherein the bypass means includes a control mechanism for varying the portion of reaction product diverted away from the recuperator means based upon the output signal of the monitoring means.

11. A reactor vessel according to claim 9, wherein the monitoring means comprises a thermocouple.

12. A reactor vessel according to claim 1, wherein the distribution means comprises at least one swirl mixing tube fluidically connected to the recuperator shell.

13. A reactor vessel according to claim 1, wherein the recuperator means comprises a recuperator shell having tubesheets for flow therethrough of at least one of: the first reactant, the second reactant, and the reaction product; and wherein the distribution means and the bypass means are fluidically connected to the recuperator shell.

14. A reactor vessel according to claim 13, wherein the distribution means comprises at least one swirl mixing tube contained within the recuperator shell.

15. A reactor vessel according to claim 14, wherein the outer shell includes a first end cap, a second end cap and means for connecting the first and second end caps.

16. A reactor vessel according to claim 2, wherein the catalyst means comprises a reforming catalyst and wherein the reaction product comprises a hydrogen-rich gas.

17. A reactor vessel according to claim 16, wherein the recuperator means comprises a recuperator shell having tubesheets for flow therethrough of at least one of: the first reactant, the second reactant, and the hydrogen-rich gas; and wherein the distribution means and the bypass means are fluidically connected to the recuperator shell.

18. A reactor vessel according to claim 17, wherein the distribution means comprises at least one swirl mixing tube fluidically connected to the recuperator shell but at a position upstream of the reforming catalyst.

19. In a reforming method wherein an incoming stream of air and steam-fuel mix are mixed at a set temperature in the presence of a catalyst in order to create a hydrogen rich gas, the improvement comprising:
providing a pressure vessel having a recuperator shell enclosed therein, the recuperator shell capable of exchanging heat between the hydrogen rich gas and at least one of: the air, the steam-fuel mix and the catalyst;
placing the catalyst inside of a reaction zone located entirely within the pressure vessel wherein mixing of the air and steam-fuel mix to create hydrogen rich gas occurs within the reaction zone;
pre-heating at least one of: the air and the steam-fuel mix, to the set temperature, wherein the pre-heating occurs entirely inside of the pressure vessel and at a position upstream of the reaction zone;
selectively directing a portion the hydrogen rich gas into the recuperator shell at a position downstream of the reaction zone, wherein the selectively directing step occurs entirely within the pressure vessel; and
as a final step, removing the hydrogen rich gas from the pressure vessel.

20. The improved method of claim 19, wherein the selectively directing step further comprises: monitoring a temperature of the steam-fuel mix in order to automatically control performance of the reforming method.
